(19) United States
(12) Patent Application Publication
(10) Pub. No.: US 2026/0056004 A1
(43) Pub. Date: Feb. 26, 2026

(54) ADAPTIVE TEMPERATURE COMPENSATION

(71) Applicant: Klingelnberg GmbH, Hückeswagen (DE)

(72) Inventor: Jan Merkert, Wipperfürth (DE)

(21) Appl. No.: 19/306,509

(22) Filed: Aug. 21, 2025

(30) Foreign Application Priority Data
Aug. 23, 2024 (DE) 10 2024 124 186.1

(51) Int. Cl. G01B 7/008; G01B 21/04

(52) U.S. Cl. CPC G01B 7/008; G01B 21/042; G01B 21/045

(57) ABSTRACT

A coordinate measuring machine includes controlled machine axes for performing measuring movements for component measurement, having at least one measuring device, such as a tactile measuring device or an optical measuring device, held by at least one of the machine axes and movable by of at least one of the machine axes, for detecting uncompensated coordinate measured values on a component to be measured, having a device for temperature compensation of the uncompensated coordinate measured values by a temperature model, wherein the temperature model is designed to process one temperature measured value or a number of temperature measured values as input variables, wherein the temperature model has compensation parameters for the uncompensated coordinate measured values and/or compensated coordinate measured values as output variables, wherein the temperature model is adaptive and adjustable on the basis of a database.

### CROSS-REFERENCE TO RELATED APPLICATIONS

This application claims the benefit of German patent application no. 10 2024 124 186.1, filed on 23 Aug. 2024, the disclosure of which is incorporated herein by reference in its entirety.

### TECHNICAL FIELD

The present disclosure relates to a coordinate measuring machine, having controlled machine axes for performing measuring movements for component measurement, having at least one measuring device held by at least one of the machine axes and movable by means of at least one of the machine axes, such as a tactile measuring device or an optical measuring device, for detecting uncompensated coordinate measured values on a component to be measured, having a device for temperature compensation of the uncompensated coordinate measured values by means of a temperature model, wherein the temperature model is designed to process one temperature measured value or a plurality of temperature measured values as input variables and wherein the temperature model has compensation parameters for the uncompensated coordinate measured values and/or compensated coordinate measured values as output variables. The disclosure also relates to a method for setting up temperature compensation for such a coordinate measuring machine.

### BACKGROUND

Modern coordinate measuring machines are capable of measuring parameters and characteristics on components to be measured with an absolute value of less than 1 micrometer. To ensure that such accurate measurements can be repeated and carried out reliably, corrections and compensations are made on the coordinate measuring machine in question.

For example, errors in the numerically controlled machine axes can be systematically recorded and inversely superimposed, sensors can be combined to achieve a reduction in residual error, and temperature tests can be carried out which make it possible to generate a temperature model of the temperature-dependent geometric behavior of a coordinate measuring machine.

Such a temperature model can be created, for example, by performing measurements on a calibration sphere in the measuring volume of the coordinate measuring machine at different temperatures. The determined sphere center serves as a reference point in subsequent measurements and can be the reference for a coordinate system of the coordinate measuring machine. The measurements are carried out under the influence of temperature control for the surrounding room, in which different temperature levels are set for defined time intervals. The results of the measurements determined under the influence of temperature, e.g., the sphere center determinations, are used with the prevailing temperatures to generate a static temperature model. The static temperature model is specified in such a way that the resulting measurement error is minimized.

Temperature tests on a single coordinate measuring machine often take several days and are carried out in a climate chamber that allows the required temperature levels to be precisely set and maintained. The temperature tests are therefore time-consuming and costly and are only carried out on a few coordinate measuring machines from a machine series. The static temperature model determined on the basis of a few coordinate measuring machines from a machine series is used for all coordinate measuring machines in the machine series in question. It is therefore assumed that coordinate measuring machines of the same design exhibit the same or at least similar temperature behavior.

In detail, this means that for a particular coordinate measuring machine in the machine series in question, the determined temperature model is set statically for all subsequent measurements. This means, for example, that a parameter set is generated which enables the calculation of correction values for one or more reference points in the coordinate system of the coordinate measuring machine from a combination of different temperature values measured during operation. This parameter set does not change during the entire operating time of the machine. It can therefore be referred to as a static parameter set of the static temperature model.

The temperature compensation method described above means that any coordinate measuring machine that has not been used directly to determine the temperature model used and is corrected with this model will only correct an average temperature-related error. In other words, this means that any coordinate measuring machine that was not used directly to determine the temperature model and is corrected using this temperature model will either overcompensate or undercompensate.

In addition, the coordinate measuring machines of a machine series are exposed to different environmental conditions in operational practice. Each installation site differs in terms of temperature conditions, which are influenced, for example, by ventilation and air conditioning systems, windows, drafts and solar radiation, neighboring heat or cold sources such as neighboring machines, aggregates, pipes, and the like.

Each coordinate measuring machine is therefore subject to environmental conditions at its installation site that differ from those at other installation sites and, above all, to various dynamic temperature or heat influences from the static temperature of the climate chamber, the dynamics of which are not taken into account by the static temperature model.

Against this background, the technical problem underlying the present disclosure is to provide an improved coordinate measuring machine and an improved method for setting up temperature compensation for such a coordinate measuring machine, which in particular enable improved temperature compensation.

The technical problem described above is solved by the features of the independent claims. Further embodiments of the disclosure are apparent from the dependent claims and the following description.

According to a first aspect, the disclosure relates to a coordinate measuring machine, having controlled machine axes for performing measuring movements for component measurement, having at least one measuring device held by at least one of the machine axes and movable by means of at least one of the machine axes, such as a tactile measuring device or an optical measuring device, for detecting uncompensated coordinate measured values on a component to be measured, having a device for temperature compensation of the uncompensated coordinate measured values by means of a temperature model, wherein the temperature model is designed to process one temperature measured value or a plurality of temperature measured values as input variables and wherein the temperature model has compensation parameters for the uncompensated coordinate measured values and/or compensated coordinate measured values as output variables. The coordinate measuring machine is characterized in that the temperature model is adaptive and can be adjusted on the basis of a database.

The coordinate measuring machine according to the disclosure enables improved temperature compensation because the temperature model can be adapted to individual machines. This means that the temperature model can be individually adapted to the geometric temperature behavior of the coordinate measuring machine in question, rather than simply adopting a temperature model created under laboratory conditions, as described in the introduction regarding the prior art.

It may be provided that the temperature model is designed to process one measured temperature gradient or a plurality of measured temperature gradients as input variables.

In this case, the coordinate measuring machine according to the disclosure enables improved temperature compensation by also compensating for temperature gradients. Under real operating conditions, fluctuations in the temperature in the vicinity of the coordinate measuring machine can occur repeatedly. This means that the ambient temperature changes over a certain period of time, wherein this temperature change can be measured as a temperature gradient in the environment and/or within the coordinate measuring machine. For this purpose, the coordinate measuring machine can have one or more temperature sensors to record temperature gradients in addition to individual temperature measurements.

Under the influence of such a temperature change, the temperatures of the components of the coordinate measuring machine also change, wherein it is apparent that the components of the coordinate measuring machine heat up or cool down to different degrees, at different rates, and overall inhomogeneously, depending on their dimensions, position, material, mass, and shape.

Temperature models that have been determined under laboratory conditions for static temperature states do not allow precise compensation for the dynamic effects under the influence of temperature gradients. In contrast, the coordinate measuring machine according to the disclosure also particularly enables temperature compensation under the influence of temperature gradients. In particular, the temperature model can be individually adapted to the ambient conditions and the machine-specific geometric behavior of the coordinate measuring machine at the end user's installation site.

It may be provided that the temperature model has a base temperature compensation, wherein the base temperature compensation has been determined on the basis of tests under laboratory conditions at a location different from the installation site of the coordinate measuring machine, such as a climate chamber or the like, on the coordinate measuring machine and/or an identically constructed coordinate measuring machine, and the temperature model has an individual temperature compensation that supplements, modifies, or replaces the base temperature compensation, which has been determined on the basis of one or more reference measurements at the installation site of the coordinate measuring machine. The installation site is in particular the current installation site of the coordinate measuring machine, especially at the end user. The location different from the installation site is, in particular, a location where the coordinate measuring machine was installed prior to the current installation site, such as an assembly hall or climate chamber.

While the base temperature compensation compensates for an average temperature error for the machine series in question for example, the individual temperature compensation enables machine-specific improvement of this base temperature compensation. This means that the coordinate measuring machine is already operational with base temperature compensation and would also be ready for use without individual temperature compensation for common tolerance requirements. Individual temperature compensation enables a further improvement in the measurement accuracy that can be achieved, even under difficult environmental conditions, if for example the coordinate measuring machine is used outside an air-conditioned measuring room.

According to one embodiment of the coordinate measuring machine, it may be provided that the base temperature compensation has compensation parameters for static temperature levels and, in particular, has compensation parameters for temperature gradients. The base temperature compensation can therefore already have compensation parameters for temperature gradients that have been determined, for example, on an identically constructed coordinate measuring machine. It applies again that the base temperature compensation already enables very precise temperature compensation, which is further improved by the individual temperature compensation.

It may be provided that the individual temperature compensation has compensation parameters for temperature gradients adapted in a machine-specific manner, in particular that the individual temperature compensation has compensation parameters adapted in a machine-specific manner for both temperature gradients and static temperature levels.

Depending on the design of the coordinate measuring machine, it may be provided that the temperature model has one or more of the models listed below: characteristic map, AI model, regression model.

The temperature model may have a characteristic map, wherein the characteristic map maps a temperature-dependent measurement deviation of the coordinate measuring machine. For example, measured temperatures and/or measured temperature gradients can serve as input variables of the characteristic map in order to determine one or more compensation parameters for compensating the temperature-related measurement deviation as output variables based on the characteristic map.

In addition, axis positions of the coordinate measuring machine can also serve as additional input variables of the characteristic map in order to determine one or more compensation parameters for compensating the temperature-related measurement deviation as output variables based on the characteristic map.

The characteristic map can be the mapping of one or more input variables to one or more output variables in a known manner. If only one input variable and one output variable are present, this can be referred to as a characteristic curve.

The characteristic map may have been determined by means of practical tests and/or simulation, e.g., FE simulation. Characteristic curves and/or curves of the characteristic map may have been determined by means of regression analysis.

For characteristic map-based temperature compensation, it may apply in particular that, for example, one or more temperatures and/or temperature gradients serve as input variables and that compensation parameters describing the temperature-related measurement deviation of the coordinate measuring machine in space are the output variables.

The characteristic map can be stored in a machine control system of the coordinate measuring machine, for example in tabular form, i.e. as a data set, and/or as a calculation rule, i.e. as a formula, function or set of curves.

Several characteristic maps can be stored in the machine control system of the coordinate measuring machine to map temperature-related measurement deviations of the coordinate measuring machine. For example, it may be provided that one characteristic map is stored for each coordinate direction. For example, it may be provided that one characteristic map is stored for each machine axis.

Alternatively or in addition, a regression model may be provided, or several regression models may be provided, to map a temperature-related measurement deviation of the coordinate measuring machine. Such a regression model may be a linear regression, a polynomial regression, or the like. For example, it may be provided that a regression model is stored for each coordinate direction. For example, it may be provided that a regression model is stored for each machine axis.

The temperature model may comprise an AI model, wherein the AI model maps a temperature-related measurement deviation of the coordinate measuring machine. The AI model may be a neural network. The neural network may be a radial basis function network. It may be provided that the neural networks have radial basis functions or interpolation functions, such as linear and nonlinear regressions.

According to one design of the coordinate measuring machine, it may therefore be provided that the temperature model has at least one neural network. The neural network may have been trained using training data that has been determined at least in part at the installation site of the coordinate measuring machine at the end user's premises.

In this case, training the neural network with training data determined at least in part at the installation site of the coordinate measuring machine at the end user's premises corresponds to the individual temperature compensation according to the disclosure.

The database can be expanded and the neural network improved in the sense of machine learning by means of multiple or repeated reference measurements and/or calibrations at the installation site.

It may be provided that the neural network is trained until a predetermined model quality has been achieved.

It may be provided that the temperature model is set up to process uncompensated coordinate measured values as input variables. The required compensation may depend not only on the determined temperature, but also on the position of the measured value acquisition within the available measurement volume. It is thus apparent that the machine axes, whose superimposed movements enable the approach to measuring positions, do not exhibit purely linear geometric temperature behavior, but require different temperature compensations depending on the axis position approached.

To take up the example of the neural network, in addition to measured values of temperatures and temperature gradients, the uncompensated coordinate measured values and/or axis positions of the machine axes can also be used as input variables in order to take into account the influence of the measuring position in the measuring volume on the deviations to be compensated. The terms “measurement deviations” and “deviations” are used synonymously in this text.

The output variables of such a neural network can either be compensation parameters for the uncompensated coordinate measured values, which are then offset against each other, and/or compensated coordinate measured values, which can be output directly as measurement results. The neural network can therefore be used directly to output compensation parameters and/or compensated coordinate measured values.

It may be provided that the temperature model has a characteristic map and/or a regression model that are set up for temperature compensation, wherein an AI model, such as a neural network, is set up for adapting the characteristic map and/or the regression model. In this case, the AI model does not generate compensation parameters, but is only intended to improve or adapt the characteristic map and/or the regression model. Thus, the compensation parameters are determined during machine operation by means of the characteristic map and/or the regression model and, in particular, not by means of the AI model.

This approach has the advantage that this type of map-based or regression-based temperature compensation is less computationally intensive than AI running live during machine operation.

The AI model can, for example, represent a meta-model for the coordinate measuring machine, which is trained and improved on the basis of test results and/or FE simulations. Such an AI model can in turn be used to improve the characteristic map and/or regression model of the coordinate measuring machine or to generate compensation parameters.

In particular, it may be provided that the AI model used to improve the characteristic map and/or the regression model of the coordinate measuring machine runs on a computer or server external to the machine control system, while the characteristic map and/or the regression model are stored and used on the machine control system. Alternatively, both the AI model and the characteristic map and/or the regression model can be stored and used on the machine control system.

Input data of the neural network for improving the characteristic map and/or the regression model can be, for example, data and/or parameters of the characteristic map and/or the regression model, sensor data, axis position and the like, wherein output variables of the neural network can be supplemented, adapted or replaced data or parameters of the characteristic map and/or the regression model.

All aspects of the temperature model are preferably computer-implemented. This means that, where reference is made to a characteristic map, a regression model, an AI model, a neural network, and the like, these are computer-implemented in each case.

According to one design of the coordinate measuring machine, it may be provided that the database contains measurement results from reference measurements and/or calibrations, in which case standards such as a ball standard or similar have been measured.

It may be provided that axis-specific compensation parameters are assigned to each machine axis.

Alternatively or in addition, it may be provided that each coordinate direction is assigned coordinate direction-specific compensation parameters.

Alternatively or in addition, it may be provided that the coordinate measured values are compensated vectorially.

According to a second aspect, the disclosure relates to a method for setting up temperature compensation for a coordinate measuring machine according to the disclosure, comprising the method steps of: providing the database; adapting the temperature model on the basis of the database.

It may be provided that the database contains data from coordinate measuring machines of the same design, wherein data is provided in particular via a network connection. In this way, data from a machine series can be collected centrally and used to improve the temperature models. The network connection may be a wired and/or wireless connection, in particular an intranet connection and/or an internet connection.

### BRIEF DESCRIPTION OF THE DRAWINGS

The disclosure is described in more detail below with reference to a drawing illustrating an exemplary embodiment. The following figures show schematically:

FIG. 1 shows a coordinate measuring machine according to the disclosure;

FIG. 2 shows a temperature compensation;

FIG. 3 shows a temperature model with a neural network;

FIG. 4 shows a further temperature model with a neural network;

FIG. 5 shows a temperature model with a neural network and a characteristic map;

FIG. 6 shows a further temperature model with a neural network and a regression model; and

FIG. 7 shows method steps of a method according to the disclosure.

### DETAILED DESCRIPTION OF THE DRAWINGS

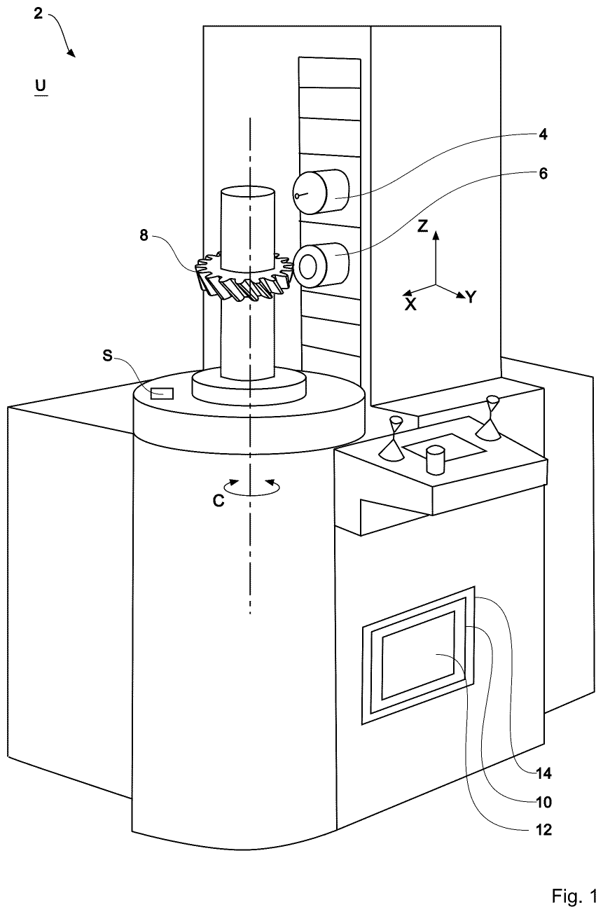

FIG. 1 shows a coordinate measuring machine 2 according to the disclosure in a perspective view.

The coordinate measuring machine 2 has controlled machine axes X, Y, Z, C for performing measuring movements for component measurement. In particular, these are CNC-controlled machine axes.

The coordinate measuring machine 2 has three controlled linear axes X, Y, Z for performing translational relative movements in three mutually orthogonal spatial directions X, Y, Z. The coordinate measuring machine 2 has a controlled rotary axis C for rotating a component 8 to be measured.

The coordinate measuring machine 2 has measuring devices 4, 6 held by the machine axes X, Y, Z and movable by means of the machine axes X, Y, Z, namely a tactile measuring device 4 and an optical measuring device 6, for recording uncompensated coordinate measured values on the component 8 to be measured. The component 8 is, in the present case, an externally helically toothed spur gear.

The coordinate measuring machine 2 has a device 10 for temperature compensation of the uncompensated coordinate measured values by means of a temperature model 12.

The device 10 for temperature compensation can be software assigned to a machine control system 14 of the coordinate measuring machine 2.

The coordinate measuring machine 2 has at least one temperature sensor S and may have a plurality of temperature sensors S.

If the temperature in an environment U of the coordinate measuring machine 2 changes, the components of the coordinate measuring machine 2 undergo temperature-related expansion or contraction. This means that the geometry of the coordinate measuring machine 2 is temperature-dependent. As a result, the measuring devices 4, 6 also shift relative to the component 8 to be measured due to the temperature.

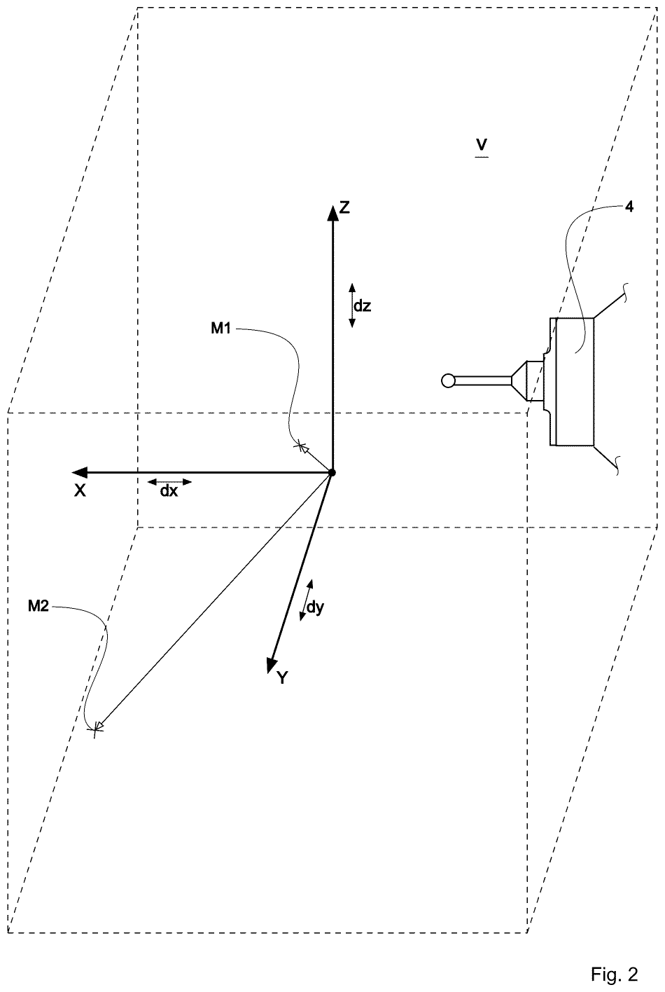

For a measuring point M1 (see FIG. 2), the coordinate measuring machine 2 therefore records different uncompensated measured values for a first ambient temperature than for a second ambient temperature that differs from the first, even though the same measuring point M1 is actually touched, e.g., by the tactile measuring device 4 on a component.

This temperature-related deviation of the measured values can be compensated using temperature model 12. Each uncompensated measured value has a value for the X coordinate, the Y coordinate, and the Z coordinate. The temperature model 12 can provide a positive or negative compensation parameter dx, dy, dz for each uncompensated measured value, which is offset against the uncompensated measured value, e.g. by addition. In this way, compensated measured values can be generated that are adjusted for the influence of temperature.

In this case, a temperature-related position change of the Z-axis, which is designed as a linear axis, may exhibit deviations in the X or Y direction in addition to longitudinal expansion in the Z direction if the temperature influences cause the Z-axis to tilt or twist. It therefore applies to all CNC-controlled machine axes X, Y, Z, C that each machine axis X, Y, Z, C can experience temperature-related deviations along each spatial direction and around each spatial direction, corresponding to the three rotational and three translational degrees of freedom in three-dimensional space.

The compensation parameters dx, dy, dz according to FIG. 2 therefore do not merely represent an axis-specific deviation, but summarize all components of the temperature-related deviations of all machine axes X, Y, Z, C in the respective spatial direction and thus compensate for the deviations of all machine axes X, Y, Z, C as a whole.

The temperature model 12 can be set up to process temperature measurements T₁, T₂, Tᵢ, with the index i=1 to n, as input variables and can also be set up to process several measured temperature gradients Tg₁, Tg₂, Tgⱼ, with the index j=1 to m, as input variables. This allows multiple temperatures and/or temperature gradients to be used as input variables. Averaged values or values calculated from sensor data can also be used as virtual temperature T_{V} and/or virtual temperature gradient Tg_{V} as input data.

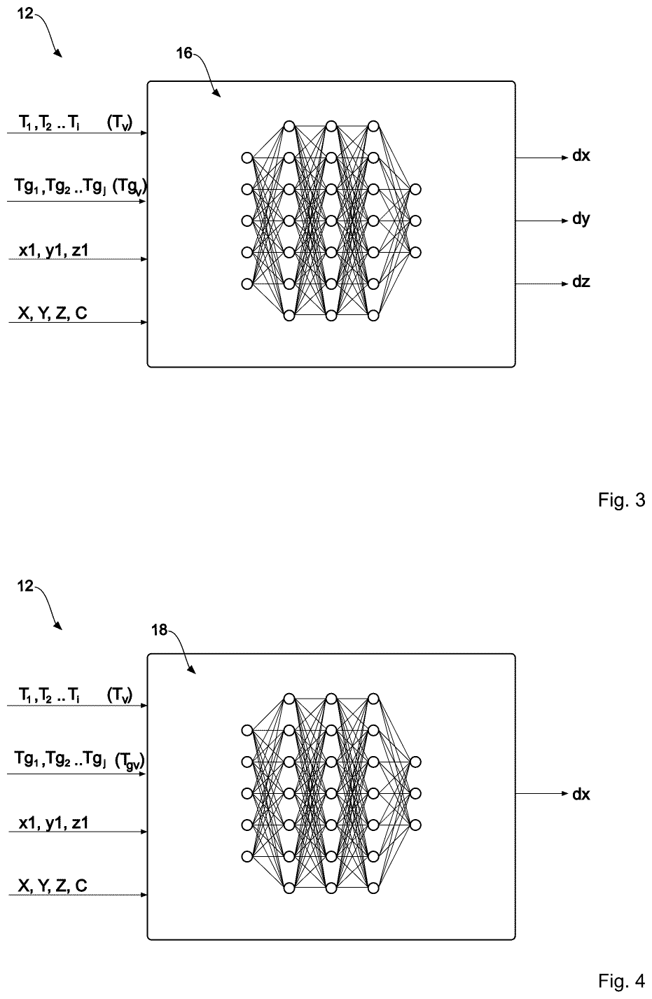

FIG. 3 shows this by way of example and schematically for a neural network 16. The temperature model 12 can be set up to output compensation parameters dx, dy, dz for the uncompensated coordinate measured values as output variables (FIG. 3).

Uncompensated measured values x1, y1, and z1 and/or axis positions of the machine axes X, Y, Z, C can also be used as input variables. The provision of the uncompensated measured values x1, y1, and z1 and/or the axis positions of the machine axes X, Y, Z, C as input variables serves to take into account the influence of the position of the measured point on the required compensation.

As already mentioned, the geometric temperature behavior of the coordinate measuring machine 2 is not homogeneous. For a measuring point M1 (see FIG. 2), different values are therefore required for temperature compensation than for a measuring point M2 that is detected within a coverable measuring volume V at a position M2 remote from M1.

The number of neurons and hidden layers, as well as the transmission and activation functions of the respective neural network, can be adapted to the specific application, wherein all figures are purely illustrative and schematic.

The temperature model 12 is adaptive and can be adjusted based on a database.

In the delivery state, the temperature model 12 has a base temperature compensation, which is improved by test results at the installation site of the coordinate measuring machine at the end user's premises. For this purpose, measurement results from reference measurements and/or calibrations are generated, wherein standards, such as a ball standard or the like, are measured in particular. Based on this extended training data, the neural network 16 can be further trained, for example, to generate the individual temperature compensation at the end user's installation site. It may be provided that the reference measurements are repeated at the end user's installation site under different temperature conditions until the respective temperature model 12 has reached a specified model quality.

The base temperature compensation can be determined on the basis of tests under laboratory conditions at a location different from the installation site of the coordinate measuring machine at the end user's premises, such as a climate chamber or the like, on the coordinate measuring machine and/or an identical coordinate measuring machine.

FIG. 4 shows another neural network 18 as an example and in schematic form. For example, it may be provided that one neural network 18 is trained for each coordinate direction, with dx being shown as an example of the output variable.

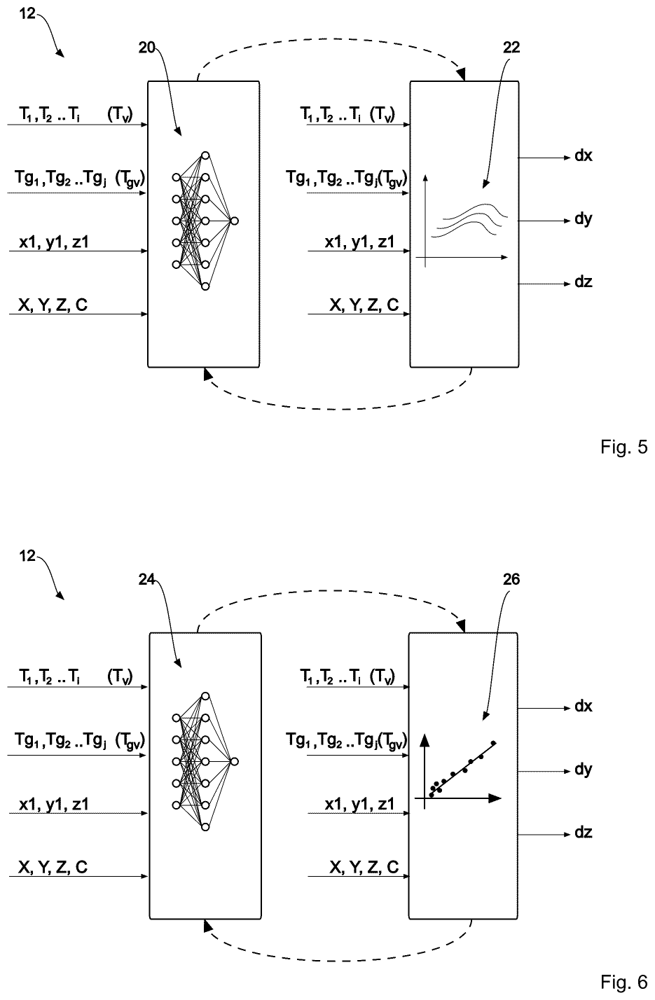

FIG. 5 shows another temperature model 12, in which both a neural network 20 and a characteristic map 22 are used. Alternatively, multiple neural networks and multiple characteristic maps can be used. The neural network 20 serves to improve the characteristic map 22. The compensation parameters dx, dy, dz are determined only by means of the characteristic map 22 and not by means of the neural network 20.

FIG. 6 shows another temperature model 12, in which both a neural network 24 and a regression model 26 are used. Alternatively, multiple neural networks and multiple regression models can be used. The neural network 24 serves to improve the regression model 26. The compensation parameters are determined only by means of the regression model 26 and not by means of the neural network 24.

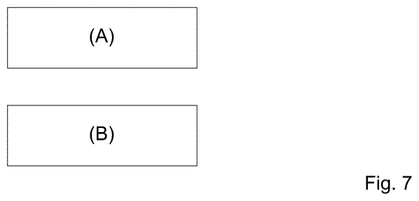

Accordingly, the disclosure provides a method for setting up temperature compensation for a coordinate measuring machine 2, comprising the method steps of: (A) providing the database; (B) adapting the temperature model 12 on the basis of the database, wherein the database contains data from coordinate measuring machines of identical design, wherein data is provided in particular via a network connection (FIG. 7).

Furthermore, method step (B) may comprise the following: providing a neural network as a temperature model and improving the neural network at the installation site of the machine at the end user's premises.

Alternatively, method step (B) may comprise the following: providing a neural network for improving a characteristic map and/or a regression model, wherein the characteristic map and/or the regression model serve to generate the compensation parameters and wherein the neural network does not serve to generate the compensation parameters.

1. A coordinate measuring machine comprising:
controlled machine axes for performing measuring movements for component measurement;
at least one measuring device held by at least one of the machine axes and movable using at least one of the machine axes, such as a tactile measuring device or an optical measuring device, for detecting uncompensated coordinate measured values on a component to be measured; and
a device for temperature compensation of the uncompensated coordinate measured values using a temperature model,
wherein the temperature model is designed to process one temperature measured value or a plurality of temperature measured values as input variables,
wherein the temperature model has compensation parameters for the uncompensated coordinate measured values and/or compensated coordinate measured values as output variables,
wherein the temperature model is adaptive and configured to be adjusted on the basis of a database.

2. The coordinate measuring machine according to claim 1, wherein
the temperature model has a base temperature compensation,
wherein the base temperature compensation has been determined on the basis of tests under laboratory conditions at a location different from the installation site of the coordinate measuring machine, on the coordinate measuring machine and/or an identically constructed coordinate measuring machine, and
the temperature model has individual temperature compensation that supplements, modifies, or replaces the base temperature compensation, which has been determined on the basis of one or more reference measurements at the installation site of the coordinate measuring machine.

3. The coordinate measuring machine according to claim 1,
wherein
the temperature model is designed to process a measured temperature gradient or a plurality of measured temperature gradients as input variables.

4. The coordinate measuring machine according to claim 3, wherein
the base temperature compensation has compensation parameters for static temperature levels and, has compensation parameters for temperature gradients.

5. The coordinate measuring machine according to claim 3,
wherein
the individual temperature compensation has compensation parameters for temperature gradients adapted in a machine-specific manner, wherein the individual temperature compensation has compensation parameters adapted in a machine-specific manner for both temperature gradients and static temperature levels.

6. The coordinate measuring machine according to claim 1,
wherein
the temperature model comprises one or more of the models listed below: characteristic map, AI model, and regression model.

7. The coordinate measuring machine according to claim 6, wherein
the temperature model comprises a neural network.

8. The coordinate measuring machine according to claim 7, wherein
the temperature model has a characteristic map, wherein the neural network is set up to adapt the characteristic map.

9. The coordinate measuring machine according to claim 1,
wherein
the temperature model is designed to process uncompensated coordinate measured values as input variables.

10. The coordinate measuring machine according to claim 1,
wherein
the database contains measurement results from reference measurements and/or calibrations, wherein standards have been measured.

11. The coordinate measuring machine according to claim 1,
wherein
each machine axis is assigned axis-specific compensation parameters and/or
each coordinate direction is assigned coordinate direction-specific compensation parameters
and/or
the coordinate measured values are compensated vectorially.

12. A method for setting up temperature compensation for a coordinate measuring machine according to claim 1, including the following method steps:
providing the database, and
adapting the temperature model on the basis of the database.

13. The method according to claim 12, wherein
the database contains data of coordinate measuring machines of identical construction, wherein data is provided via a network connection.
